(19) United States
(12) Patent Application Publication
(10) Pub. No.: US 2024/0286523 A1
(43) Pub. Date: Aug. 29, 2024

(54) DEMAND-SIDE FLEXIBILITY OPTIMIZATION SYSTEM FOR VEHICLE-TO-GRID SYSTEMS

(71) Applicant: Accenture Global Solutions Limited, Dublin (IE)

(72) Inventors: Takashi Saeki, Tokyo (JP); Yumiko Suzuki, Tokyo (JP); Shin Moriga, Tokyo (JP)

(21) Appl. No.: 18/169,307

(22) Filed: Feb. 15, 2023

(51) Int. Cl. B60L 55/00; G06Q 50/06

(52) U.S. Cl. CPC B60L 55/00; G06Q 50/06; B60L 2260/40

(57) ABSTRACT

Implementations for receiving, by DSF system, data representative of a set of constants, determining, by the DSF system, data representative of a set of predictions, at least a portion of predictions being determined from a set of ML models, optimizing, by the DSF system, a value of an objective function subject to a set of constraints, the value of the object function being optimized for a time interval based on a set of constants, the set of predictions, and a set of variables, providing, by the DSF system, the set of variables as output of optimizing the value of the objective function, and transmitting, by the DSF system, instructions to a set of assets of the power grid to provision power based on values of at least a sub-set of variables in the set of variables, the set of assets at least partially comprising a set of EVs.

### BACKGROUND

Electric vehicles (EVs) have seen increasing development over the last several years. A catalyst for this has been the development of high-capacity batteries that are able to store sufficient energy to provide EVs with practical driving ranges. With the development of high-capacity batteries, so-called vehicle-to-grid (V2G) technology has been developed that enables EVs to provide energy to a power grid. In general, V2G can be described as a charging technology that enables batteries of EVs to give back to the power grid, treating batteries as backup storage cells for the power grid as well as to power EVs.

Energy pushed to or pulled from the power grid can be based on supply and demand for electricity at any given time. In traditional approaches, balancing supply and demand can include predicting future market loads (demand) and scheduling charging cycles to minimize peaks. For example, machine learning (ML) models have been used to generate predictions based on wider market trends. In some examples, price signal algorithms can be used to avoid charging at peak hours and/or at certain locations to create a dynamic charging rate at any given time depending on the available data and demand. However, such traditional approaches are limited to providing schedules for returning EVs to the power grid and scheduling charging cycles of the EV itself. For example, such traditional approaches fail to achieve a balance with an eye toward optimizing overall efficiency.

### SUMMARY

Implementations of the present disclosure are generally directed to a demand-side flexibility (DSF) system for optimizing efficiency in power grids that include vehicle-to-grid (V2G) technology. More particularly, implementations of the present disclosure are directed to a DSF system that determines a set of patterns for operating a power grid over a given time interval, each pattern defining a proportion of power to provide from one or more electric vehicles (EVs).

In some implementations, actions include receiving, by DSF system, data representative of a set of constants, determining, by the DSF system, data representative of a set of predictions, wherein at least a portion of predictions in the set of predictions is determined from a set of machine learning (ML) models, optimizing, by the DSF system, a value of an objective function subject to a set of constraints, the value of the object function being optimized for a time interval based on a set of constants, the set of predictions, and a set of variables, values of variables in the set of variables being adjusted during optimization, providing, by the DSF system, the set of variables as output of optimizing the value of the objective function, and transmitting, by the DSF system, instructions to a set of assets of the power grid to provision power based on values of at least a sub-set of variables in the set of variables, the set of assets at least partially comprising a set of EVs. Other implementations of this aspect include corresponding systems, apparatus, and computer programs, configured to perform the actions of the methods, encoded on computer storage devices.

These and other implementations can each optionally include one or more of the following features: the set of constants includes one or more of a power generation unit price for the time interval, a DSF unit price for the time interval, and a generation plan amount for the time interval; the set of variables includes a first value representing an amount of power to source from the set of EVs to the power grid in place of high-cost power generation, a second pattern indicating an amount of power to source to the power grid from the set of EVs in place of market procurement, and a third value indicating an amount of power from the set of EVs to be sold to a market; the set of variables includes an incentive that is communicated to respective owners of EVs in the set of EVs to encourage owners to plug respective EVs into the power grid during the time interval; the set of variables includes an upper limit and a lower limit for smoothing any instances of power shortages during the time interval; the set of predictions includes a power shortage amount predicted for the time interval, a binary flag indicating excess or deficiency for the time interval, a market trade unit price for the time interval, a power volume of available EV batteries for the time interval, a supply rate for the time interval, and an amount of power for sourcing from EVs for the time interval; actions further includes executing, by an asset of a power generation source in the power grid, one or more instructions to provide power to the power grid from the power generation source based on a value of a respective variable in the set of variables; actions further include executing, by an asset associated with an EV in the power grid, one or more instructions to provide power to the power grid from the EV based on a value of a respective variable in the set of variables; and the asset includes a charging station that the EV is connected to for electrical communication.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts an example system that can execute implementations of the present disclosure.

FIG. 2 depicts a conceptual architecture including a demand-side flexibility (DSF) system in accordance with implementations of the present disclosure.

FIGS. 3A-3C depict respective scenarios in which energy provisioning is optimized in accordance with implementations of the present disclosure as compared to conventional approaches.

FIG. 4 depicts an example process in accordance with implementations of the present disclosure.

Like reference numbers and designations in the various drawings indicate like elements.

### DETAILED DESCRIPTION

Implementations of the present disclosure are generally directed to a demand-side flexibility (DSF) system for optimizing efficiency in power grids that include vehicle-to-grid (V2G) technology. More particularly, implementations of the present disclosure are directed to a DSF system that determines a set of patterns for operating a power grid over a given time interval, each pattern defining a proportion of power to provide from power generation systems and a proportion of power to provide from one or more electric vehicles (EVs). As described in further detail herein, the DSF system determines the set of patterns based on an optimization function that optimizes efficiencies and that receives a set of predictions of a set of machine learning (ML) models as input. The power grid is operated over the time interval based on the set of patterns determined for the time interval.

In some implementations, actions include receiving, by DSF system, data representative of a set of constants, determining, by the DSF system, data representative of a set of predictions, wherein at least a portion of predictions in the set of predictions is determined from a set of ML models, optimizing, by the DSF system, a value of an objective function subject to a set of constraints, the value of the object function being optimized for a time interval based on a set of constants, the set of predictions, and a set of variables, values of variables in the set of variables being adjusted during optimization, providing, by the DSF system, the set of variables as output of optimizing the value of the objective function, and transmitting, by the DSF system, instructions to a set of assets of the power grid to provision power based on values of at least a sub-set of variables in the set of variables, the set of assets at least partially comprising a set of EVs.

To provide further context, and as introduced above, EVs have seen increasing development over the last several years. A catalyst for this has been the development of high-capacity batteries that are able to store sufficient energy to provide EVs with practical driving ranges. With the development of high-capacity batteries, so-called vehicle-to-grid (V2G) technology has been developed that enables EVs to provide energy to a power grid. In general, V2G can be described as a charging technology that enables batteries of EVs to give back to the power grid, treating batteries as backup storage cells for the power grid as well as to power EVs. Implementing V2G includes use of bidirectional charging stations to push energy to and pull energy from connected EVs.

Energy pushed to or pulled from the power grid can be based on supply and demand for electricity at any given time. For example, energy pulled from batteries of EVs can be used to power anything that is connected to the power grid (e.g., houses, buildings). Accordingly, V2G enables the use of energy stored in batteries of EVs to balance the power grid by storing energy when there is a surplus in the power grid and providing energy back to the power grid when there is a wider demand.

In traditional approaches, balancing supply and demand can include predicting future market loads (demand) and scheduling charging cycles to minimize peaks. For example, machine learning (ML) models have been used to generate predictions based on wider market trends. In some examples, price signal algorithms can be used to avoid charging at peak hours and/or at certain locations to create a dynamic charging rate at any given time depending on the available data and demand. However, such traditional approaches are limited to providing schedules for returning EVs to the power grid and scheduling charging cycles of the EV itself. For example, such traditional approaches fail to achieve a balance with an eye toward optimizing overall efficiency.

In view of the foregoing, implementations of the present disclosure are directed to a DSF system that determines a set of patterns for operating a power grid over a given time interval, each pattern defining a proportion of power to provide from power generation systems and a proportion of power to provide from one or more EVs. As described in further detail herein, the DSF system determines the set of patterns based on an optimization function that optimizes efficiencies and that receives a set of predictions of a set of ML models as input. The power grid is operated over the time interval based on the set of patterns determined for the time interval. As described in further detail herein, implementations of the present disclosure optimize efficiencies in power grids by storing and selectively accessing electricity as inventory in order to eliminate inefficiencies in controlling the output of energy in balancing supply and demand. More particularly, the DSF system of the present disclosure leverages power, stored on aggregate, as an inventory from a group of individual EVs owned and operated by individuals in a decentralized, unmanaged manner. For example, the DSF system of the present disclosure enables the general public to connect their EVs to V2G equipment at home or at charging stations at the time of discharge. One or more power generation enterprises can control the direct flow of power from the EVs to the power grid. As such, the DSF system of the present disclosure can be described as enabling herd management of the relatively large number of EVs owned and operated by ordinary households. As described herein, this herd management is optimized using ML prediction for statistical and optimization calculations for optimal control and can be executed over the Internet.

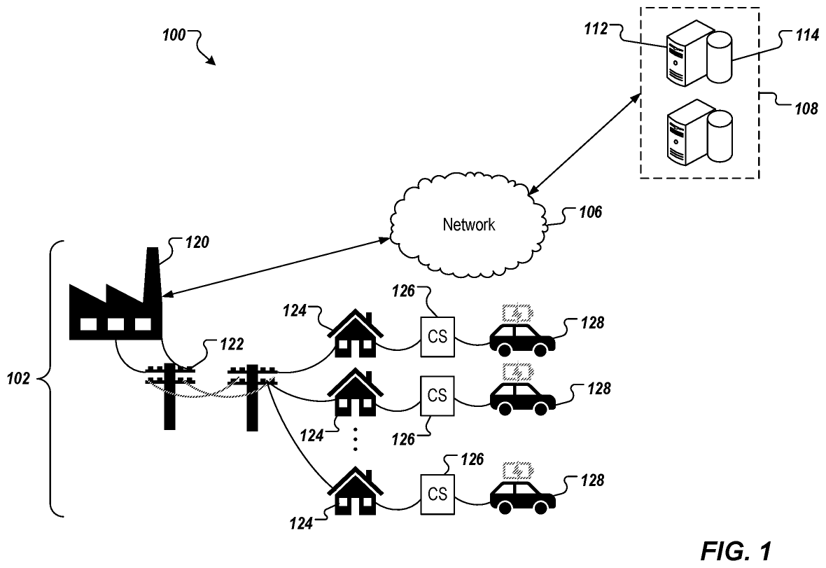

FIG. 1 depicts an example system 100 that can execute implementations of the present disclosure. The example system 100 includes a power grid 102, a back-end system 108, and a network 106. In some examples, the network 106 includes a local area network (LAN), wide area network (WAN), the Internet, or a combination thereof, and connects web sites, devices (e.g., computing devices), and back-end systems (e.g., the back-end system 108). In some examples, the network 106 can be accessed over a wired and/or a wireless communications link.

In the depicted example, the back-end system 108 includes at least one server system 112, and data store 114 (e.g., database and knowledge graph structure). In some examples, the at least one server system 112 hosts one or more computer-implemented services that users can interact with using computing devices. For example, the server system 112 can host one or more applications that are provided as part of a DSF system in accordance with implementations of the present disclosure.

In the depicted example, the power grid 102 includes a power generation station 120, a power transmission system 122, residential locations 124, charging stations (CSs) 126, and EVs 128. In some examples, the CS 126 can be installed at the residential location 124 to enable charge/discharge of the EV 128, which is owned and operated by an individual (e.g., private citizen). Although a handful of EVs 128 are depicted, it is contemplated that implementations of the present disclosure can be realized with tens, hundred, thousands, even millions of EVs 128 to selectively provide power to the power grid 102, as described in detail herein. Also, although residential locations 124 are depicted, it is contemplated that implementations of the present disclosure can be used with any appropriate location that is able to provide power to and receive power from EVs, such as commercial locations having CSs.

In some examples, each CS 126 executes software that communicates with the power grid 102 to provide power to and/or receive power from a respective EV 128. In some examples, the power generation station 120 generates (electrical) power (e.g., using fossil fuels, nuclear, and/or renewable sources, such as hydro-electric, wind, solar) that is distributed through the power grid. In some examples, power is distributed for charging of the EVs 128. For example, power is transmitted through the power transmission system 122 to the residential locations 124 and the CSs 126 and on to the EVs 128. In some examples, power is transmitted from one or more of the EVs 128 into the power grid 102. That is, for example, each CS 126 is bidirectional to provide power from the grid to a respective EV 128 or from the respective EV 128 to the power grid.

In some implementations, the back-end system 108 hosts the DSF system of the present disclosure. As described in further detail herein, the DSF system determines a set of patterns for operating the power grid 102 over a given time interval, each pattern defining a proportion of power to provide from one or more of the EVs 128 in different scenarios. As described in further detail herein, the DSF system determines the set of patterns based on an objective function that optimizes efficiencies and that receives a set of predictions of a set of ML models as input. The power grid 102 is operated over the time interval based on the set of patterns determined for the time interval.

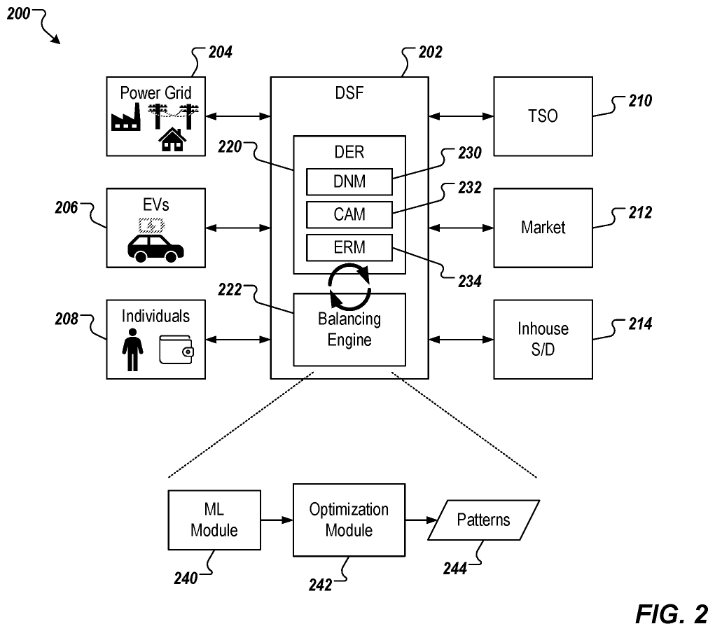

FIG. 2 depicts a conceptual architecture 200 including a DSF system 202 in accordance with implementations of the present disclosure. In the example of FIG. 2, the conceptual architecture 200 includes the DSF system 202 that processes data representative of a power grid 204, EVs 206, individuals 208, a transmission system operator (TSO) 210, a market 212, and an inhouse supply/demand (S/D) system 214. In some examples, the TSO 210 can be described as an agency that receives orders from and coordinates the supply/demand of power generation enterprises (e.g., power companies). In some examples, the inhouse S/D system 214 is that of a respective power generation enterprise that enables the power generation enterprise to adjust their own supply and demand. In some examples, multiple inhouse S/D systems 214 can be provided, each inhouse S/D systems 214 being that of a respective power generation enterprise. In the example of FIG. 2, the DSF system 202 includes a distributed energy resources (DER) system 220 and a balancing engine 222.

In the example of FIG. 2, the DER system 220 is conceptually depicted and includes a distribution network manager (DNM) 230, one or more control area managers (CAMs) 232, and one or more energy resource managers (ERMs) 234. In some examples, the DNM 230 executes system-level operations and stores data representative of a DER portfolio including assets, connectivity, and capabilities. In some examples, each CAM 232 hosts and manages groups of assets. In some examples, each ERM 234 interfaces with and manages assets. In the context of the present disclosure, example assets can include, without limitation, EVs, locations (e.g., residential, commercial), energy generators (e.g., fossil fuel, nuclear, renewables), and battery systems (e.g., energy storage independent of EVs). An example DER system 202 can include, without limitation, the Spirae Wave® control platform provided by Spirae, LLC of Fort Collins, Colorado, USA. In some examples, the Spirae Wave® control platform can be described as a scalable architecture for integrating and managing DERs within power grids.

In some implementations, and as described in further detail herein, the DER system 220 can provide instructions to the power grid 204 for operating the power grid 204 during a time interval based on a set of patterns determined for the time interval. For example, the DER system 220 can provide instructions to one or more assets within the power grid 204 to such that a proportion of power is provided from one or more power generation systems (e.g., fossil-fuel, nuclear, solar, hydro-electric) and a proportion of power to provide from one or more of the EVs 206 (e.g., the EVs 128 of FIG. 1). For example, each asset can be associated with a respective ERM 234 that enables the asset to receive instructions from and respond to the DER system 220 (e.g., the DNM 230 of the DER system 220).

In accordance with implementations of the present disclosure, the balancing engine 222 can determine a set of patterns (e.g., including one or more patterns) for operation of assets based on a balance between supply and demand. In some implementations, the balancing engine 222 determines the set of patterns for a time interval (e.g., 15 minutes, 30 minutes, 1 day) for operation of assets based on the set of patterns during the time interval. In some examples, sets of patterns can be determined for time intervals within a forthcoming period of time (e.g., 24 hours). For example, and without limitation, sets of patterns can be determined for the next 24 hours, each set of patterns being for a respective 30-minute time interval within those 24 hours (e.g., 1440 minutes (=24 hours)/30 minutes→48 sets of patterns). In this non-limiting example, instructions can be issued for the next 24 hours for operation based on the sets of patterns, which can be provided as [(xa₁, xb₁, xc₁), . . . , (xa₄₈, xb₄₈, xc₄₈)], where (xa₁, xb₁, xc₁) is for a first 30-minute time interval, (xa₂, xb₂, xc₂) is for a next 30-minute time interval, and so on.

With continued reference to FIG. 2, the balancing engine 222 includes a ML module 240 and an optimization module 242 that provides one or more patterns 244. In some examples, and as described in further detail herein, the ML module 240 receives input that is processed through a set of ML models to provide a set of predictions, and the optimization module 242 executes maximization of an objective function based on a set of inputs and a set of constraints to determine a set of patterns 244.

In further detail, for each time interval, the balancing engine 222 optimizes a set of variables by maximizing an objective function based on a set of inputs and a set of constraints. In some examples, the objective function represents an efficiency in provisioning power to meet demand for the time interval. This can be represented as:

$$max {\sum }_{t} {O}_{t}$$

where O is the objective function and t is the time interval (e.g., 15 minutes, 30 minutes, 1 day). In some examples, the set of inputs includes a set of constants and a set of predictions. In some examples, the set of constants includes a power generation unit price MCₜ (e.g., $/kWh), a DSF unit price ECₜ (e.g., $/kWh), and a generation amount (plan) MVₜ (e.g., kWh). In some examples, the generation amount MVₜ represents an amount of power that is to be generated by a power generation system per a scheduled plan. In some examples, the set of predictions includes a power shortage amount NVₜ (e.g., kWh), a binary flag flgₜ (e.g., 0, 1) indicating excess or deficiency, a market trade unit price JCₜ (e.g., $/kWh), a power volume of available EV batteries EVₜ, a maximum discharge rate Dₜ, an amount of power for sourcing from EVs EVSₜ, and a connection probability Jₜ. Each is discussed in further detail herein.

In accordance with implementations of the present disclosure, each of NVₜ, flgₜ, JCₜ, EVₜ, EVSₜ, and Jₜ is provided as or is based on output from one or more ML models. That is, for example, a set of ML models is provided, each ML model providing a respective prediction or a portion of a respective prediction in the set of predictions.

For example, the power shortage amount NVₜ is determined as a difference between a power generation amount Pₜ and a power demand amount PDₜ, where Pₜ is determined from a power generation plan and PDₜ is determined from a power demand ML model. In some examples, the power generation plan provides a schedule of power generation amounts for each time interval from each of one or more assets (e.g., fossil-fuel, nuclear, renewable) and can be provided from an operator of a power generation station (e.g., the power generation station 120 of FIG. 1). In some examples, the power demand ML model receives an input set (e.g., date, precipitation, humidity, temperature, population, etc.) and provides PDₜ as output. In some examples, the power demand ML model can be provided as any appropriate type of ML model (e.g., a state space model, a time-series forecasting model, a regression model) that is trained using any appropriate training technique (e.g., supervised learning). In some examples, the ML model can include, for example, a regression model that considers time-series data. For example, a state space model (e.g., time-series forecasting models that can take into account cycles and trends in hand with customized logic), or XGBoost, LightGBM with added features related to time-series.

As another example, the binary flag flgₜ is determined based on whether Pₜ is less than PDₜ. For example, if Pₜ is less than PDₜ, a power generation shortage is expected for the time interval and flgₜ is set to a first value (e.g., 1), and, if Pₜ is not less than PDₜ, a power generation shortage is not expected for the time interval and flgₜ is set to a second value (e.g., 0).

As another example, the market trade unit price JCₜ is determined from a market trade ML model that receives an input set (e.g., date, precipitation, humidity, temperature, population, etc.) and provides JCₜ as output. In some examples, the market trade ML model can be provided as any appropriate type of ML model (e.g., a state space model, a time-series forecasting model, a regression model) that is trained using any appropriate training technique (e.g., supervised learning). In some examples, the ML model can include, for example, a regression model that considers time-series data. For example, a state space model (e.g., time-series forecasting models that can take into account cycles and trends in hand with customized logic), or XGBoost, LightGBM with added features related to time-series.

As another example, the power volume of available EV batteries EVₜ is determined from an EV storage ML model that receives an input set (e.g., attributes of EV owners (demographics, regional), date, precipitation, humidity, temperature, population, etc.) and provides EVₜ as output. In some examples, the EV storage ML model can be provided as any appropriate type of ML model (e.g., non-linear model, light gradient boosted model, gradient boosted model, regression model) that is trained using any appropriate trained technique (e.g., supervised learning).

In accordance with implementations of the present disclosure, the objective function is optimized (e.g., maximized) by determining values of variables in the set of variables that result in an optimized value of Oₜ. T is a duration for optimization (e.g., 48 hours (2×24 hours)), and t is a time of duration for optimization (e.g., t=1,2,3, . . . , T). In some examples, the set of variables that is to be optimized includes a first value xaₜ, a second value xbₜ, and a third value xcₜ. In some examples, the first value xaₜ represents an amount of power to source from the power grid from the EVs over the time interval t in a scenario where the power from the EVs replaces high-cost power generation. In some examples, the second value xbₜ indicates an amount of power to source to from the EVs instead of procuring from the market. In some examples, the third value xcₜ indicates an amount of power from the EVs that can be sold to a market. Example values are discussed in further detail herein.

With respect to EV groups, in some examples, if a region includes more than a threshold number of EVs that could be used for discharge to the power grid (e.g., 1 million EVs), EV groups are implemented to reduce computational complexity. In some examples, and to reduce the computational complexity, each EV group is treated as a single EV with one or more EVs belonging to the group. That is, one EV per EV group is considered.

In some implementations, in considering EV groups, G indicates the number of groups of EVs and g indicates identifiers of respective groups (e.g., g=1,2,3, . . . , G). The number of EVs per group is provided as E_{g}. For EV groups, the following definitions can be provided. As noted above, g represents an EV group. An individual EV is represented as e. Here, EV_{e,t} represents the power volume of an individual EV at time t, EVSₑ represents an amount of power available from the individual EV, and J_{e,t} represents a connection probability of the individual EV at time t. In view of this, the following relationships can be provided:

$${EV}_{g , t} = {\sum }_{e = 1}^{{E}_{g}} {EV}_{e , t} \\ {EVS}_{g} = {\sum }_{e = 1}^{{E}_{g}} {EVS}_{e} \\ {J}_{g , t} = \frac{1}{{E}_{g}} {\sum }_{e = 1}^{{E}_{g}} {J}_{e , t}$$

In the above, EV_{g,t} is the power volume (kWh) stored per EV group g at time t, which can be determined from an EV storage ML model that receives an input set (e.g., attributes of EV owners (demographics, regional), date, precipitation, humidity, temperature, population, etc.) and provides EV_{g,t} as output. In some examples, the EV storage ML model can be provided as any appropriate type of ML model (e.g., non-linear model, light gradient boosted model, gradient boosted model, regression model) that is trained using any appropriate trained technique (e.g., supervised learning). In some examples, the ML model can include, for example, a regression model that considers time-series data. For example, a state space model (e.g., time-series forecasting models that can take into account cycles and trends in hand with customized logic), or XGBoost, LightGBM with added features related to time-series. Also in the above, EV_{g,t} accounts for the amount of electricity stored including the DSF supply. In this manner, and because the optimization constraint states that the DSF supply (discharged) is less than the EV, the amount discharged to the DSF is accounted for to avoid underestimation.

In some examples, EVS_{g,d} is the sum amount of power supply (kWh) per EV group g for a duration d (e.g., 24 hours) and can be determined from an EV available power ML model that receives an input set (e.g., attributes of EV owners (demographics, regional), date, precipitation, humidity, temperature, population, etc.) and provides EVS_{g,d} as output. In some examples, the EV available power ML model can be provided as any appropriate type of ML model (e.g., non-linear model, light gradient boosted model, gradient boosted model, regression model) that is trained using any appropriate trained technique (e.g., supervised learning). In some examples, the ML model can include, for example, a regression model that considers time-series data. For example, a state space model (e.g., time-series forecasting models that can take into account cycles and trends in hand with customized logic), or XGBoost, LightGBM with added features related to time-series.

In some examples, EVSP_{g,d} is an amount of power increase resulting from incentives, discussed in further detail herein, for a duration d (e.g., 24 hours) and can be determined using an incentive power increase ML model that receives an input set (e.g., attributes of EV owners (demographics, regional), date, precipitation, humidity, temperature, population, etc.) and provides EVSP_{g,d} as output. In some examples, the incentive power increase ML model can be provided as any appropriate type of ML model (e.g., non-linear model, light gradient boosted model, gradient boosted model, regression model) that is trained using any appropriate trained technique (e.g., supervised learning). In some examples, the ML model can include, for example, a regression model that considers time-series data. For example, a state space model (e.g., time-series forecasting models that can take into account cycles and trends in hand with customized logic), or XGBoost, LightGBM with added features related to time-series.

In some examples, grouping of EVs can be achieved by clustering (e.g., hierarchical clustering) based on order of proximity. In some examples, clustering is performed until the number of groups is less than a threshold number of groups (e.g., 1 million). Here, if the number of EVs is also less than the threshold number of EVs, only one EV per group is needed. For clustering, proximity and distance are considered, such that EV_{e,t}, EVS_{e,d}, J_{e,t}, EVSP_{e,d}, and JP_{e,t} individual EVs (e, representing an individual EV) are used to determine closeness and group EVs that are deemed sufficiently similar in terms of these parameters. That is, for example, a distance between EVs can be determined based on their respective EV_{e,t}, EVS_{e,d}, J_{e,t}, EVSP_{e,d}, and JP_{e,t}, and, if the distance is less than a threshold distance, the EVs are grouped.

The connection probability is considered in the constraints to account for likelihood that EVs will be connected to the power grid and available for discharge. For example, this can depend on the time-based (e.g., hourly) convenience of individuals to connect their EV to the power grid for discharge (e.g., hourly discharge). The connection probability J_{g,t} represents a prediction per time t that individuals in EV group g will connect their Evs. In some examples, the connection probability is determined using a ML model, which can include, for example, a regression model that considers time-series data. For example, a state space model (e.g., time-series forecasting models that can take into account cycles and trends in hand with customized logic), or XGBoost, LightGBM with added features related to time-series. In some examples, input to the ML model can include, without limitation, attributes of individuals (e.g., demographics, regional attributes), date, and climate (e.g., weather, precipitation, humidity, temperature), and the output is the connection probability of EV group g at time t.

In view of the above, the following example relationship can be provided:

$${O}_{g , t} = {f ( {MC}_{t} , {EC}_{t} , {flg}_{t} , {JC}_{t} , {xa}_{t} , {xb}_{t} , {xc}_{t} )}_{g}$$

During optimization, values of the variables in the set of variables are adjusted until the value of the objective function is optimized. In some examples, the objective function is optimized under the set of constraints. In some implementations, the set of constraints includes the following constraints:

TABLE 1
Example Constraints

| Constraint | Description |
|---|---|
| 0 ≤ xaₜ ≤ MVₜ; | High-cost generation replacement up to |
| (t = 1, . . . , T) | the planned amount of high-cost |
| | generation. |
| lowbound * ybₜ ≤ xbₜ ≤ NVₜ * ybₜ; | The power shortage replacement is |
| (t = 1, . . . , T) | limited to the predicted power shortage. |
| | There is also a minimum transaction |
| | volume in the power market. |
| lowbound * ycₜ ≤ xcₜ ≤ M1 * ycₜ; | There is also a minimum transaction |
| (t = 1, . . . , T) | volume in the power market. |
| $x {a}_{t} + x {b}_{t} + x {c}_{t} \leq {\sum }_{g} {d}_{g , t} * {J}_{g , t} ;$ (t = 1, . . . , T) | Discharge up to the usable amount considering connection probability. |
| ${\sum }_{t} {d}_{g , t} \leq E V {S}_{g} ;$ (g = 1, . . . , G) | Accounting for increased power available from EV group. |
| 0 ≤ d_{g,t} ≤ D * E_{g}; | Bounding for discharge amount per |
| (g = 1, . . . , G; t = 1, . . . , T) | group at time based on maximum |
| | discharge rate. |
| 0 ≤ d_{g,t} ≤ EV_{g,t}; | Bounding for discharge amount per |
| (g = 1, . . . , G; t = 1, . . . , T) | group at time based on power volume |
| | of group at time. |
| xa_{g,t}, xb_{g,t}, xc_{g,t} ∈ R | Real numbers. |
| ybₜ, ycₜ ∈ {0, 1} | Binary whether pattern B, C use per |
| | time t. |
| d_{g,t} ∈ R | Real number. |

D is the maximum rate of discharge (e.g., constant, 3 kWh per 30 minutes), d_{g,t} is a discharge amount per EV group g at time t, EV_{g,t} is the power volume (kWh) stored per EV group g at time t, and EVS_{g} is the sum amount of power supply (kWh) per EV group g, as noted above. Further, a large numbers for optimization M₁ is provided as a constant that is determined as a multiple (e.g., 10˜100) of the sum of NVₜ over all intervals t.

Through optimization of the object function (e.g., maximizing Oₜ), a value for each variable in the set of variables is provided, the set of variables including xa_{g,t}, xb_{g,t}, xc_{g,t}, ybₜ, ycₜ, and d_{g,t}. Power is provisioned to the power grid based on the values determined for the set of variables. Optimization solution methods for determining optimal variables are not limited, but the optimal solution is obtained by exact solution methods, or approximate solution methods such as meta-heuristics in mathematical optimization or mathematical programming.

In some implementations, the objective function can account for incentives that the power generation company may provide to owners of the EVs. For example, the owners of the EVs may be incentivized to make their respective EVs available (i.e., by plugging the EVs into the grid) to enable power to be pushed from the EVs to the power grid. In some examples, incentives can be in the form of payments to the EV owners and/or discounts on the power bills issued to the EV owners. As another example, for commercial CSs, charging fee discounts can be provided. As another example, long-term contracts (x kWh per day, y kWh per week) can be provided. Implementations of the present disclosure can be realized with any appropriate form of incentives.

In further detail, in accounting for incentives, the set of variables that is to be optimized includes the first value xaₜ, the second value xbₜ, the third value xcₜ, and an incentive Iₜ. In some examples, the set of predictions includes an increased supply EVSP_{g}, which is a predicted (using a respective ML model) amount of power available from EVs that would result from the incentive. In some examples, the increased supply EVSP_{g} is determined from a an incentive power increase ML model that receives an input set (e.g., the incentive Iₜ, attributes of EV owners (demographics, regional), date, precipitation, humidity, temperature, population, etc.) and provides EVSP_{g} as output. In some examples, the supply rate ML model can be provided as any appropriate type of ML model (e.g., non-linear model, light gradient boosted model, gradient boosted model, regression model) that is trained using any appropriate trained technique (e.g., supervised learning). In some examples, if historical data is insufficient or absent for training of a supply rate ML model, a rule-based algorithm can be implemented to determine EVSP_{g} (e.g., at least for an initial period until sufficient historical data is collected).

In accounting for incentives, the following relationship can be provided:

$${O}_{g , t} = {f ( M {C}_{t} , {EC}_{t} , {flg}_{t} , J {C}_{t} , {xa}_{t} , {xb}_{t} , {xc}_{t} , {I}_{t} )}_{g}$$

Through optimization of the object function (e.g., maximizing Oₜ), values for each variable in the set of variables are provided, the set of variables including xaₜ, xbₜ, xcₜ, Iₜ, ybₜ, ycₜ, and d_{g,t}. In some implementations, in considering incentives, the set of constraints includes the following constraints:

TABLE 2
Example Constraints (incentives)

| Constraint | Description |
|---|---|
| 0 ≤ xaₜ ≤ MVₜ; | High-cost generation replacement up to the |
| (t = 1, . . . , T) | planned amount of high-cost generation. |
| lowbound * ybₜ ≤ xbₜ ≤ NVₜ * ybₜ; | The power shortage replacement is limited to |
| (t = 1, . . . , T) | the predicted power shortage. |
| | There is also a minimum transaction volume |
| | in the power market. |
| lowbound * ycₜ ≤ xcₜ ≤ M1 * ycₜ; | There is also a minimum transaction volume |
| (t = 1, . . . , T) | in the power market. |
| $x {a}_{t} + x {b}_{t} + x {c}_{t} \leq {\sum }_{g} {d}_{g , t} * min ( {J}_{g , t} + {JP}_{g , t} , 1 ) ;$ (t = 1, . . . , T) | Discharge up to the usable amount considering connection probability. Set the minimum value compared to 1 to ensure that it does not exceed 1 since it is a probability. |
| ${\sum }_{t} {d}_{g , t} \leq E V {S}_{g} + E V S {P}_{g} ;$ (g = 1, . . . , G) | Accounting for increased power available from EV group. |
| 0 ≤ d_{g,t} ≤ D * E_{g}; | Bounding for discharge amount per group at |
| (g = 1, . . . , G; t = 1, . . . , T) | time based on maximum discharge rate. |
| 0 ≤ d_{g,t} ≤ EV_{g,t}; | Bounding for discharge amount per group at |
| (g = 1, . . . , G; t = 1, . . . , T) | time based on power volume of group at time. |
| xa_{g,t}, xb_{g,t}, xc_{g,t} ∈ R | Real numbers. |
| ybₜ, ycₜ ∈ {0, 1} | Binary whether pattern B, C use per time t. |
| d_{g,t} ∈ R | Real number. |

In the constraints of Table 2, JP_{g,t} indicates an increase in connection probability as a result of the incentives.

With regard to Iₜ, and although not limited, for the convenience of calculation, among the set of variables, the incentive Iₜ can be treated a specially. For example, while changing the incentive Iₜ as a fixed value, the optimization is performed each time by updating the predicted values JP_{g,t}, EVSP_{g} and the objective function. The optimal incentive Iₜ is determined as a super variable by comparing the values of each objective function.

In some implementations, after the incentive Iₜ is determined through optimization of the object function, the incentive Iₜ is communicated to owners of EVs. In this manner, the owners can be made aware of the incentive Iₜ and respond to the incentive Iₜ. For example, and without limitation, a message can be communicated to a device of each owner (e.g., a text message to a mobile phone, a message within a mobile application executed on a mobile phone), the message including data representative of the incentive Iₜ and the time interval (e.g., Hi Owner! You will receive an X % discount on your power bill, if you plug your EV into a charging station during the time period from Y to Z.). In some examples, an owner can respond to the message to indicate that the owner is accepting the offer (e.g., sending a responsive test message indicating acceptance, clicking on an acceptance button within the mobile application).

In some implementations, the objective function can account for smoothing power shortages. In further detail, in accounting for smoothing power shortages, the set of constants also includes large numbers for optimization M₁, M₂, the set of predictions remains unchanged, but the set of variables that is to be optimized includes the first pattern xaₜ, the second pattern xbₜ, the third pattern xcₜ, an upper limit on power shortage Up and a lower limit on power shortage Lw. In some examples, M₁ and M₂ are constants that are determined as a multiple (e.g., 10˜100) of the sum of NVₜ over all intervals t. In accounting for smoothing power shortages, the set of constraints includes the following constraints:

TABLE 3
Example Constraints (smoothing power shortages)

| Constraint | Description |
|---|---|
| 0 ≤ xaₜ ≤ MVₜ; | High-cost generation replacement up to |
| (t = 1, . . . , T) | the planned amount of high-cost |
| | generation. |
| lowbound * ybₜ ≤ xbₜ ≤ NVₜ * ybₜ; | The power shortage replacement is |
| (t = 1, . . . , T) | limited to the predicted power shortage. |
| | There is also a minimum transaction |
| | volume in the power market. |
| lowbound * ycₜ ≤ xcₜ ≤ M1 * ycₜ; | There is also a minimum transaction |
| (t = 1, . . . , T) | volume in the power market. |
| $x {a}_{t} + x {b}_{t} + x {c}_{t} \leq {\sum }_{g} {d}_{g , t} * {J}_{g , t} ;$ (t = 1, . . . , T) | Discharge up to the usable amount considering connection probability. |
| ${\sum }_{t} {d}_{g , t} \leq E V {S}_{g} ;$ (g = 1, . . . , G) | Accounting for increased power available from EV group. |
| 0 ≤ d_{g,t} ≤ D * E_{g}; | Bounding for discharge amount per |
| (g = 1, . . . , G; t = 1, . . . , T) | group at time based on maximum |
| | discharge rate. |
| 0 ≤ d_{g,t} ≤ EV_{g,t}; | Bounding for discharge amount per |
| (g = 1, . . . , G; t = 1, . . . , T) | group at time based on power volume |
| | of group at time. |
| Lw − M2 * flgₜ ≤ NVₜ − xbₜ ≤ | Set upper and lower bounds on power |
| Up + M2 * flgₜ; | shortages. |
| (t = 1, 2, 3, . . . , T) | |
| xa_{g,t}, xb_{g,t}, xc_{g,t} ∈ R | Real numbers. |
| ybₜ, ycₜ ∈ {0, 1} | Binary whether pattern B, C use per |
| | time t. |
| d_{g,t} ∈ R | Real number. |

In accounting for smoothing power shortages, the following relationship can be provided:

$${O}_{g , t} = {f ( {MC}_{t} , {EC}_{t} , {flg}_{t} , {JC}_{t} , {xa}_{t} , {xb}_{t} , {xc}_{t} , Up , Lw )}_{g}$$

Through optimization of the object function (e.g., maximizing Oₜ), values for each variable in the set of variables are provided, the set of variables including xaₜ, xbₜ, xcₜ, Up, Lw.

In some implementations, the objective function can account for incentives and smoothing power shortages. For example, the objective function, and optimization thereof, can include the features discussed above with respect to each of incentives and smoothing power shortages. In accounting for incentives and smoothing power shortages, the following relationship can be provided:

$${O}_{g , t} = {f ( {MC}_{t} , {EC}_{t} , {flg}_{t} , {JC}_{t} , {xa}_{t} , {xb}_{t} , {xc}_{t} , M , {I}_{t} Up , Lw )}_{g}$$

Through optimization of the object function (e.g., maximizing O_{g,t}), values for each variable in the set of variables are provided, the set of variables including xa_{g,t}, xb_{g,t}, xc_{g,t}, UP, Lw, Iₜ, ybₜ, ycₜ, and d_{g,t}. In accounting for groups of EVs, connection probability, incentives, and smoothing power shortages, the set of constraints includes the following constraints:

TABLE 4
Example Constraints (groups, connection probability, incentives, smoothing)

| Constraint | Description |
|---|---|
| 0 < xaₜ ≤ MVₜ; (t = 1, ... , T) | Set upper and lower bounds to the amount of |
| lowbound * ybₜ ≤ xbₜ ≤ NVₜ * ybₜ; | discharge for each pattern. |
| (t = 1, . . . , T) | |
| lowbound * ycₜ ≤ xcₜ ≤ M1 * ycₜ; | |
| (t = 1, . . . , T) | |
| $x {a}_{t} + x {b}_{t} + x {c}_{t} \leq {\sum }_{g} {d}_{g , t} * min ( {J}_{g , t} + J {P}_{g , t} , 1 ) ;$ (t = 1, . . . , T) | Discharge up to the usable amount. |
| ${\sum }_{t} {d}_{g , t} \leq E V {S}_{g} , + E V S {P}_{g} ;$ (g = 1, . . . , G) | Accounting for increased power available from EVs due to incentives. |
| 0 ≤ d_{g,t} ≤ D * E_{g}; | Bounding for discharge amount per group at |
| (g = 1, . . . , G; t = 1, . . . , T) | time based on maximum discharge rate. |
| 0 ≤ d_{g,t} ≤ EV_{g,t}; | Bounding for discharge amount per group at |
| (g = 1, . . . , G; t = 1, . . . , T) | time based on power volume of group at time. |
| Lw − M2 * flgₜ ≤ NVₜ − xbₜ ≤ Up + M2 * flgₜ; | Set upper and lower limits on power |
| (t = 1, 2, 3, . . . , T) | shortages. |
| xa_{g,t}, xb_{g,t}, xc_{g,t} ∈ R | Real numbers. |
| ybₜ, ycₜ ∈ {0, 1} | Binary whether pattern B, C use per time t. |
| d_{g,t} ∈ R | Real number. |

In accordance with implementations of the present disclosure, optimization of O_{g,t} not only optimizes the patterns xa_{g,t}, xb_{g,t}, xc_{g,t}, but also optimizes discharge of individual EVs d_{g,t}, as well as considering a maximum discharge rate (e.g., for each individual EV per 30 minutes), connection probability, and EV groups.

Implementations of the present disclosure also account for prediction uncertainty of the ML models. For example, in some instances, one or more of the ML models can provide an inaccurate prediction. For purposes of illustration, a non-limiting example can be considered, in which, after optimization of O, it is determined that the DSF system will provide 50,000 kW at 17:00 on December 2. This can be determined on December 1, and the power generation company can be informed of this and determine to reduce 50,000 kW from the marginal plane for 17:00 on December 2. At 17:00 on December 2, it can occur that the DSF system can only provide 40,000 kW from EVs, which is 10,000 kW less than predicted. This can be informed to the power generation company, which then has to determine how to account for the shortfall. Accordingly, if the amount available for discharge from EVs is out of line, it becomes problematic because it will cause a shift in the power generation company's plans in advance (such as the planned replacement of high-cost generation in Pattern A, the planned replacement of market procurement in Pattern B, the planned market sale in Pattern C, etc.).

In view of this, implementations of the present disclosure provide credit intervals for predictions of the ML models. In some examples, the credit interval (also referred to as a confidence interval) quantifies the uncertainty of a prediction. In some examples, the credit intervals of predictions provided by state-space models can be determined using distributions (e.g., a normal distribution) over the prediction. For example, the prediction can be provided as the mean (m) and a standard deviation (σ) can be determined. A multiple (q) of the standard deviation can be determined that accounts for a threshold percentage of the distribution (e.g., 90%) and the lower bound (e.g., m−qσ) can be used as the predicted value. In some examples, credit intervals of predictions provided by other types of models (e.g., LightGBM, XGBoost) can be determined using quantile regression to predict X % (e.g., 5%) percentile values directly, which can be used to determine a lower bound of uncertainty

For purposes of illustration, the non-limiting example can be considered, in which, after optimization of O, it is determined that the DSF system will provide 50,000 kW. Distribution analysis and/or quantile regression can be applied (e.g., depending on type of ML model(s)) and it can be determined that a lower bound of 40,000 kW and an upper bound of 60,000 kW account for the threshold percentage of the uncertainty. In view of this, the predicted value can be provided as the lower bound of 40,000 KW. Consequently, on December 1, the power generation company can be informed of this and determine to reduce 40,000 kW from the marginal plane for 17:00 on December 2.

In limited instances, and even using a credit interval, it can still occur that the predicted value is incorrect, and a shortfall in power from the DSF system is to be accounted for. This can occur, for example, as a result of unpredictable events. In such occurrences, the power generation can make up for the deficiency itself and/or the spot market can be used to make up the deficiency, and the power generation company can report to the network operator, which can be charged a fine.

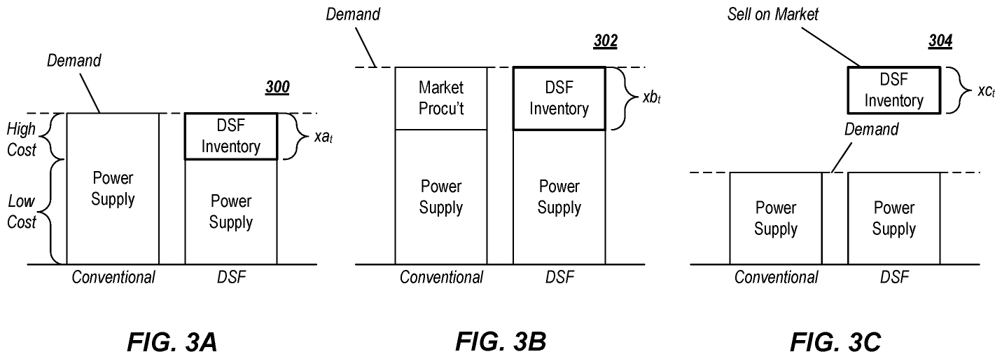

FIGS. 3A-3C depict respective scenarios 300, 302, 304 in which energy provisioning is optimized in accordance with implementations of the present disclosure as compared to conventional approaches.

FIG. 3A depicts a scenario 300 representing sufficiency of the power generation amount in meeting the power demand amount (e.g., Pₜ is at least equal to Dₜ). In some examples, in the scenario 300, the power generation station (e.g., the power generation station 120 of FIG. 1) can replace power generated by marginal units with power from batteries of the EVs (e.g., one or more of the EVs 128 of FIG. 1). Consequently, resource efficiencies are gained, because power from the batteries of the EVs displaces power that would be generated, particularly from high-cost power generation means. In some examples, aggregation costs from EV storage batteries (including incentives for EV owners) are lower than the unit cost of marginal unit generation. In this manner, the power generation company can still incur profits for supplying power even though generating less power.

FIG. 3B depicts a scenario 302 representing insufficiency of the power generation amount in meeting the power demand amount (e.g., Pₜ is less than Dₜ). In some examples, in the scenario 302, the power generation station (e.g., the power generation station 120 of FIG. 1) can replace market procurement of power (i.e., the power generation company buying power from another power generation company) with power from batteries of the EVs (e.g., one or more of the EVs 128 of FIG. 1). Consequently, resource efficiencies are gained, because power from the batteries of the EVs displaces power that would be generated by the other power generation company and purchased on the market. In some examples, aggregation costs from EV storage batteries (including incentives for EV owners) are lower than the market price. In this manner, the power generation company can still incur profits for supplying power by avoiding purchasing power in the market.

FIG. 3C depicts a scenario 304 representing sufficiency of the power generation amount in meeting the power demand amount (e.g., Pₜ is not less than Dₜ). In some examples, in the scenario 304, the power generation station (e.g., the power generation station 120 of FIG. 1) can readily supply the demand and the power from batteries of the EVs (e.g., one or more of the EVs 128 of FIG. 1) can be provided as an inventory of power, at least some of which can be sold on the market. This can occur in a situation where aggregation costs from EV storage batteries (including incentives for EV owners) are lower than profit on sales of power from the EVs in the market.

In some implementations, values can be combined to provide a pattern. For example, power from EVs can be used to make up a deficit in power generation (e.g., Pₜ is not less than Dₜ) and can be sold in the market. This can occur in instances where the power available from the EVs exceeds the amount of power needed to make up a deficit in power generation.

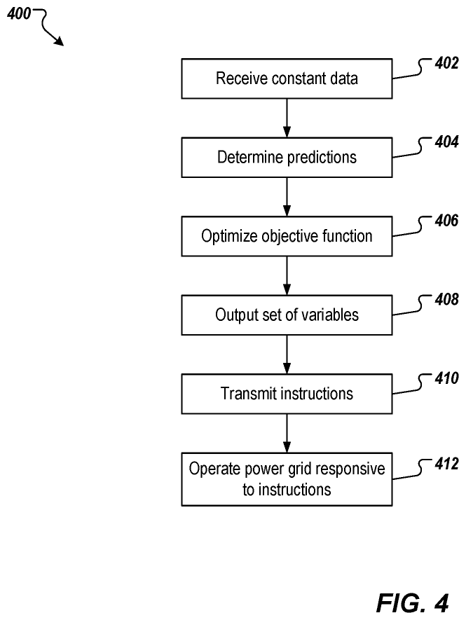

FIG. 4 depicts an example process 400 that can be executed in implementations of the present disclosure. In some examples, the example process 400 is provided using one or more computer-executable programs executed by one or more computing devices. In accordance with implementations of the present disclosure, the example process 400 is executed to determine operation of a power grid during a period of time p and for each time interval t within the period of time p. For example, the period of time p can be a date (e.g., 2023 Jan. 31). In some examples, the example process 400 is executed at a period of time p−1 (e.g., 2021 Jan. 30) to determine how the power grid is to operate for each time interval t in the period of time p (e.g., the next day). For example, and as discussed above by way of non-limiting example, sets of patterns can be determined for 30-minute time intervals t within a forthcoming period of time p (e.g., a next day). For example, and without limitation, sets of patterns can be determined for the next 24 hours, each set of patterns being for a respective 30-minute time interval t within those 24 hours (e.g., 1440 minutes/30 minutes→48 sets of patterns). In this non-limiting example, instructions can be issued for the next 24 hours for operation based on the sets of patterns. For example, the period of time p can be representative of tomorrow and the sets of patterns can be provided as [(xa₁, xb₁, xc₁), . . . , (xa₄₈, xb₄₈, xc₄₈)]ₚ, which is determined today (p−1).

Constant data is received (402). For example, and as described in detail herein, a set of constants can be received by the balancing engine 222 of the DSF system 202 of FIG. 2. In some examples, the set of constants includes one or more of a power generation unit price for the time interval, a DSF unit price for the time interval, and a generation plan amount for the time interval. For example, the balancing engine 222 can receive values of each of the constants in the set of constants from one or more sources (e.g., the TSO 210, the market 212, the power grid 204). Predictions are determined (404). For example, and as described in detail herein, the balancing engine 222 can provide input to a set of ML models (e.g., executed by the ML module 240), which process the input to provide predictions in the set of predictions. In some examples, the set of predictions includes a power shortage amount predicted for the time interval, a binary flag indicating excess or deficiency for the time interval, a market trade unit price for the time interval, a power volume of available EV batteries for the time interval, a supply rate for the time interval, and an amount of power for sourcing from EVs for the time interval. In some examples, input to one or more of the ML models can include a date (e.g., indicative of the time interval), precipitation, humidity, temperature, population, demographics, and the like.

An objective function is optimized (406). For example, and as described in detail herein, the objective function O is optimized by the optimization module 242. In some examples, optimization includes adjusting values of variables to determine a maximum value of the objective function. A set of variables is output (408). For example, and as described in detail herein, a set of variables is provided as output of the optimization and can include a first value representing an amount of power to source from the set of EVs to the power grid during the time interval instead of high-cost power generation, a second value indicating an amount of power to source to the power grid from the set of EVs instead of market procurement, and a third value indicating an amount of power from the set of EVs to be sold to a market. In some examples, the set of variables includes an incentive that is communicated to respective owners of EVs in the set of EVs to encourage owners to plug respective EVs into the power grid during the time interval. In some examples, the set of variables includes an upper limit and a lower limit for smoothing any instances of power shortages during the time interval.

Instructions are transmitted (410) and the power grid is operated responsive to the instructions (412). For example, and as described in detail herein, the DER system 220 can provide instructions to the power grid 204 for operating the power grid 204 during the time interval based on a set of variables determined for the time interval. For example, the DER system 220 can provide instructions to one or more assets within the power grid 204 such that a proportion of power is provided from one or more power generation systems (e.g., fossil-fuel, nuclear, solar, hydro-electric) and a proportion of power to provide from one or more of the EVs 206 (e.g., the EVs 128 of FIG. 1). For example, each asset can be associated with a respective ERM 234 that enables the asset to receive instructions from and respond to the DER system 220 (e.g., the DNM 230 of the DER system 220).

Implementations of the present disclosure achieve multiple advantages. For example, through leveraging batteries of EV, power procurement (and costs thereof) in times of power shortages is reduced, running high unit-cost power generators in times of power shortages is reduced, greenhouse gas emissions are reduced, and procuring fuel from overseas is reduced. These reductions are maximized through optimization of the objective function in accordance with implementations of the present disclosure. Further, rather than implementing optimal recharge/discharge control using stocked power at a single facility or on a single grid, a larger-scale, more significant effect can be achieved by having a group of EV storage batteries owned by individuals in the entire area and the power generation company, as a single source, taking the lead to leverage the power provided by the EVs. In addition, by using EV storage batteries owned by individuals, there is no need to build a large-scale storage facility for the power grid, avoiding the implicit expense in resources, time, and cost, as well as avoiding batteries that would eventually need to be disposed of. In this manner, the storage capacity of EVs can be fully utilized and power generation opportunities can be activated to the maximum extent possible, thereby benefiting the environment, the general public, and power generation companies.

As another example, incentives enable EV owners to collectively act as aggregators to aggregate more power supply, which will lead to lower fuel procurement costs, lower electricity procurement costs, and lower greenhouse gas emissions. These reductions are maximized through optimization of the objective function in accordance with implementations of the present disclosure.

As another example, and considering smoothing, when there is a shortage of power (even if the EV storage batteries are used to compensate for the shortage), implementations of the present disclosure enable recharging and discharging of the EV batteries, such that the power shortage is smoothed out in the time intervals during which power is in short supply. In this manner, the maximum amount of electricity procured for the shortage is reduced, resulting in a reduction in the amount of power that should originally be procured and leading to a reduction in electricity power costs. This leads to a reduction in power procurement costs that is maximized through optimization of the objective function in accordance with implementations of the present disclosure. Implementations of the present disclosure also stabilize provision of power from the power grid within the respective region.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method for operating a power grid that include vehicle-to-grid (V2G) technology, the method comprising:
receiving, by demand-side flexibility (DSF) system, data representative of a set of constants;
determining, by the DSF system, data representative of a set of predictions, wherein at least a portion of predictions in the set of predictions is determined from a set of machine learning (ML) models;
optimizing, by the DSF system, a value of an objective function subject to a set of constraints, the value of the object function being optimized for a time interval based on the a of constants, the set of predictions, and a set of variables, values of variables in the set of variables being adjusted during optimization;
providing, by the DSF system, the set of variables as output of optimizing the value of the objective function; and
transmitting, by the DSF system, instructions to a set of assets of the power grid to provision power based on values of at least a sub-set of variables in the set of variables, the set of assets at least partially comprising a set of electric vehicles (EVs).

2. The method of claim 1, wherein the set of constants comprises one or more of a power generation unit price for the time interval, a DSF unit price for the time interval, and a generation plan amount for the time interval.

3. The method of claim 1, wherein the set of variables comprises a first value representing an amount of power to source from the set of EVs to the power grid in place of high-cost power generation, a second pattern indicating an amount of power to source to the power grid from the set of EVs in place of market procurement, and a third value indicating an amount of power from the set of EVs to be sold to a market.

4. The method of claim 1, wherein the set of variables comprises an incentive that is communicated to respective owners of EVs in the set of EVs to encourage owners to plug respective EVs into the power grid during the time interval.

5. The method of claim 1, wherein the set of variables comprises an upper limit and a lower limit for smoothing any instances of power shortages during the time interval.

6. The method of claim 1, wherein the set of predictions comprises a power shortage amount predicted for the time interval, a binary flag indicating excess or deficiency for the time interval, a market trade unit price for the time interval, a power volume of available EV batteries for the time interval, a supply rate for the time interval, and an amount of power for sourcing from EVs for the time interval.

7. The method of claim 1, further comprising executing, by an asset of a power generation source in the power grid, one or more instructions to provide power to the power grid from the power generation source based on a value of a respective variable in the set of variables.

8. The method of claim 1, further comprising executing, by an asset associated with an EV in the power grid, one or more instructions to provide power to the power grid from the EV based on a value of a respective variable in the set of variables.

9. The method of claim 8, wherein the asset comprises a charging station that the EV is connected to for electrical communication.

10. A system, comprising:
one or more processors; and
a computer-readable storage device coupled to the one or more processors and having instructions stored thereon which, when executed by the one or more processors, cause the one or more processors to perform operations for operating a power grid that include vehicle-to-grid (V2G) technology, the operations comprising:
receiving, by demand-side flexibility (DSF) system, data representative of a set of constants;
determining, by the DSF system, data representative of a set of predictions, wherein at least a portion of predictions in the set of predictions is determined from a set of machine learning (ML) models;
optimizing, by the DSF system, a value of an objective function subject to a set of constraints, the value of the object function being optimized for a time interval based on the a of constants, the set of predictions, and a set of variables, values of variables in the set of variables being adjusted during optimization;
providing, by the DSF system, the set of variables as output of optimizing the value of the objective function; and
transmitting, by the DSF system, instructions to a set of assets of the power grid to provision power based on values of at least a sub-set of variables in the set of variables, the set of assets at least partially comprising a set of electric vehicles (EVs).

11. The system of claim 10, wherein the set of constants comprises one or more of a power generation unit price for the time interval, a DSF unit price for the time interval, and a generation plan amount for the time interval.

12. The system of claim 10, wherein the set of variables comprises a first value representing an amount of power to source from the set of EVs to the power grid in place of high-cost power generation, a second pattern indicating an amount of power to source to the power grid from the set of EVs in place of market procurement, and a third value indicating an amount of power from the set of EVs to be sold to a market.

13. The system of claim 10, wherein the set of variables comprises an incentive that is communicated to respective owners of EVs in the set of EVs to encourage owners to plug respective EVs into the power grid during the time interval.

14. The system of claim 10, wherein the set of variables comprises an upper limit and a lower limit for smoothing any instances of power shortages during the time interval.

15. The system of claim 10, wherein the set of predictions comprises a power shortage amount predicted for the time interval, a binary flag indicating excess or deficiency for the time interval, a market trade unit price for the time interval, a power volume of available EV batteries for the time interval, a supply rate for the time interval, and an amount of power for sourcing from EVs for the time interval.

16. The system of claim 10, wherein operations further comprise executing, by an asset of a power generation source in the power grid, one or more instructions to provide power to the power grid from the power generation source based on a value of a respective variable in the set of variables.

17. The system of claim 10, wherein operations further comprise executing, by an asset associated with an EV in the power grid, one or more instructions to provide power to the power grid from the EV based on a value of a respective variable in the set of variables.

18. The system of claim 17, wherein the asset comprises a charging station that the EV is connected to for electrical communication.

19. Non-transitory computer-readable storage media coupled to the one or more processors and having instructions stored thereon which, when executed by the one or more processors, cause the one or more processors to perform operations for operating a power grid that include vehicle-to-grid (V2G) technology, the operations comprising:
receiving, by demand-side flexibility (DSF) system, data representative of a set of constants;
determining, by the DSF system, data representative of a set of predictions, wherein at least a portion of predictions in the set of predictions is determined from a set of machine learning (ML) models;
optimizing, by the DSF system, a value of an objective function subject to a set of constraints, the value of the object function being optimized for a time interval based on the a of constants, the set of predictions, and a set of variables, values of variables in the set of variables being adjusted during optimization;
providing, by the DSF system, the set of variables as output of optimizing the value of the objective function; and
transmitting, by the DSF system, instructions to a set of assets of the power grid to provision power based on values of at least a sub-set of variables in the set of variables, the set of assets at least partially comprising a set of electric vehicles (EVs).

20. The non-transitory computer-readable storage media of claim 19, wherein the set of constants comprises one or more of a power generation unit price for the time interval, a DSF unit price for the time interval, and a generation plan amount for the time interval.

21. The non-transitory computer-readable storage media of claim 19, wherein the set of variables comprises a first value representing an amount of power to source from the set of EVs to the power grid in place of high-cost power generation, a second pattern indicating an amount of power to source to the power grid from the set of EVs in place of market procurement, and a third value indicating an amount of power from the set of EVs to be sold to a market.

22. The non-transitory computer-readable storage media of claim 19, wherein the set of variables comprises an incentive that is communicated to respective owners of EVs in the set of EVs to encourage owners to plug respective EVs into the power grid during the time interval.

23. The non-transitory computer-readable storage media of claim 19, wherein the set of variables comprises an upper limit and a lower limit for smoothing any instances of power shortages during the time interval.

24. The non-transitory computer-readable storage media of claim 19, wherein the set of predictions comprises a power shortage amount predicted for the time interval, a binary flag indicating excess or deficiency for the time interval, a market trade unit price for the time interval, a power volume of available EV batteries for the time interval, a supply rate for the time interval, and an amount of power for sourcing from EVs for the time interval.

25. The non-transitory computer-readable storage media of claim 19, wherein operations further comprise executing, by an asset of a power generation source in the power grid, one or more instructions to provide power to the power grid from the power generation source based on a value of a respective variable in the set of variables.

26. The non-transitory computer-readable storage media of claim 19, wherein operations further comprise executing, by an asset associated with an EV in the power grid, one or more instructions to provide power to the power grid from the EV based on a value of a respective variable in the set of variables.

27. The non-transitory computer-readable storage media of claim 26, wherein the asset comprises a charging station that the EV is connected to for electrical communication.
